(19) United States
(12) Patent Application Publication
(10) Pub. No.: US 2012/0296969 A1
(43) Pub. Date: Nov. 22, 2012

(54) APPARATUS AND METHOD OF OBJECTIVELY RATING MEMBERS OF AN ONLINE GROUP

(75) Inventor: Christopher Howard, Cambridge, MA (US)

(73) Assignee: LIBBOO LTD., Boston, MA (US)

(21) Appl. No.: 13/475,337

(22) Filed: May 18, 2012

Related U.S. Application Data
(60) Provisional application No. 61/487,855, filed on May 19, 2011.

(51) Int. Cl. G06F 15/16

(52) U.S. Cl. 709/204

(57) ABSTRACT

A method and apparatus for objectively rating users of a collaborative writing system forms an online group having a plurality of members, and assigns one or more roles to each of the members within the group. One or more members of the group produce at least one digital writing within the online group. The method then monitors online activity of each member in the group with regard to 1) other users of the system and 2) the digital writing(s) produced by the one or more members, and calculates, for each member, a numerical influencer score for each assigned role as a function of the monitored online activity. The influencer score indicates the influence of the member in each assigned role within the group.

### PRIORITY

This patent application claims priority from provisional U.S. patent application No. 61/487,855 filed May 19, 2011 entitled, “APPARATUS AND METHOD FOR RATING DIGITAL MEDIA,” and naming Christopher Howard as inventor, the disclosure of which is incorporated herein, in its entirety, by reference.

### FIELD OF THE INVENTION

The invention generally relates to digital media and, more particularly, the invention relates to rating digital writings and members of a group producing digital writings.

### BACKGROUND OF THE INVENTION

The digitization of media is opening up new opportunities for many individuals across the globe. Those who once did not consider themselves authors, producers, editors, or artists are now, in effect, and unbeknown to some, established content creating professionals with the required tools at their disposal. For example, many such people can produce digital writings by using, among other things, blogs, photography websites, online music creation sites, online book creation sites, etc . . . .

This influx of new content creators therefore requires metrics and mechanisms whereby people can be differentiated from one another to allow others to gain insight into their abilities in an easily understood and consistent way. Current methods known to the inventors do not provide such a mechanism.

### SUMMARY OF THE INVENTION

In accordance with one embodiment of the invention, a method of objectively rating users of a collaborative writing system forms an online group having a plurality of members, and assigns one or more roles to each of the members within the group. One or more members of the group each produce at least one digital writing within the online group, and each digital writing is associated with one or more roles of a member. The method then monitors (at least in part in a computer process) online activity of each member in the group with regard to 1) other members in their role(s) and 2) the digital writing(s) produced by the one or more members in their role(s), and calculates, for each member, a numerical influencer score for each assigned role as a function of the monitored online activity. The influencer score indicates the influence of the member in each assigned role within the group. Finally, the method optionally stores the role(s) and associated influencer scores in a digital storage device.

The online group forms a portion of the larger collaborate writing system having a plurality of users. The plurality of members are users of the larger online group, and the larger online group includes one or more users that are not members of the online group. Some embodiments monitor online activity of the members and then assign the one or more roles (e.g., writer, a reader, a marketer, and an editor) to each member based on the monitored activity.

For each member, the method may calculate the rate of change of the numerical influencer score for at least one of the roles over a time period, and then, for the at least one role, form a rate list that lists each member as a function of the rate of change of the numerical influencer score. The rate list objectively indicates the rate of change of influence of the members in the at least one role. Alternatively or in addition, the method also may form a rank listing for each role. In that case, each rank listing includes a list of one or more members of the online group in an order based upon the numerical influencer scores for each member assigned to that role. For example, for a given role (e.g., writer), the rank list may list members from the highest score to the lowest score.

The method may form the online group by dynamically adding members over a given period of time while continuing to calculate numerical influencer scores over the given time. Moreover, any number of different techniques may be used to calculate the influencer score, such as by calculating a weighted sum as a function of the monitored online activity. In addition, the influencer score may fall within a predefined scale having a maximum influencer score and a minimum influencer score.

Various embodiments may calculate the numerical influencer score (for one of the members) as a function of both:
a. the monitored online activity of each member with regard to the one member in his/her role(s), and
b. the monitored online activity of each member in the group with regard to digital writing produced by the one member in his/her role(s).

In accordance with another embodiment of the invention, an apparatus for objectively rating members of an online group has a role assignment module configured to assign one or more roles to each of the members within the group. In a manner similar to other embodiments, one or more members of the group each produce at least one digital writing within the online group, and each digital writing is associated with one or more roles of a member. The apparatus also has a monitor, operatively coupled with the role assignment module, configured to monitor (at least in part in a computer process) online activity of each member in the group with regard to 1) other members in their role(s) and 2) the digital writing(s) produced by the one or more members in their role(s). The apparatus further has a scorer operatively coupled with the monitor. The scorer is configured to calculate, for each member, a numerical influencer score for each assigned role as a function of the monitored online activity. The influencer score indicates the influence of the member in each assigned role within the group.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below, wherein:

FIG. 1 schematically shows a system for producing digital writings according to an embodiment of the invention;

FIG. 2A shows a representation of two non-overlapping subgroups of members of an online group implemented using the system embodiment;

FIG. 2B shows a representation of two overlapping subgroups of members of the online group;

FIG. 2C shows a representation of two subgroups of members of the online group where one subgroup is contained within the other;

FIG. 3 shows a representation of members and roles within a subgroup of members;

FIG. 4 is a flowchart showing a method for objectively rating members of an online group by calculating scores;

FIGS. 5A and 5B illustrate graphical displays for showing the calculated scores to users of an online collaborative writing system; and

FIG. 6 shows various relevant modules in an apparatus embodiment of the invention.

### DESCRIPTION OF ILLUSTRATIVE EMBODIMENTS

In illustrative embodiments, an apparatus and method objectively rate the roles of members in an online group by monitoring activity of their fellow members. To that end, the apparatus and method form the online group and monitor, if applicable, online activity of each member with regard to other members in their roles, and the digital writing(s) produced by certain groups of members in their role(s). Based on the monitored information, the apparatus and method calculate, for each member, a numerical influencer score indicating that members influence in their various role(s). Details of illustrative embodiments are discussed below.

As used in this description and the accompanying claims, the following terms shall have the meanings indicated, unless the context otherwise requires:

A “digital writing” is an electronic document with text and optional still images (including cover art, figures, and illustrations) but not moving images or sound. Audiovisual works and other such supplemental media may be associated with a digital writing, but do not form part of the digital writing.

An “online group” is a group of individuals, organizations, and/or entities that collectively produce digital writings, using a system for producing such writings that is accessed via a data communications network such as the Internet.

A “member” is an individual, organization, or entity that participates in an online group. A member of an online group may have helped to produce zero, one, or more than one digital writing.

A “role” is a name given to a type of relationship between a member and a digital writing. Roles may include, for example: reader, author, illustrator, editor, critic, publicist, and agent, among others. A member of an online group may have zero, one, or more than one role with respect to any given digital writing, and may have different roles with respect to different digital writings.

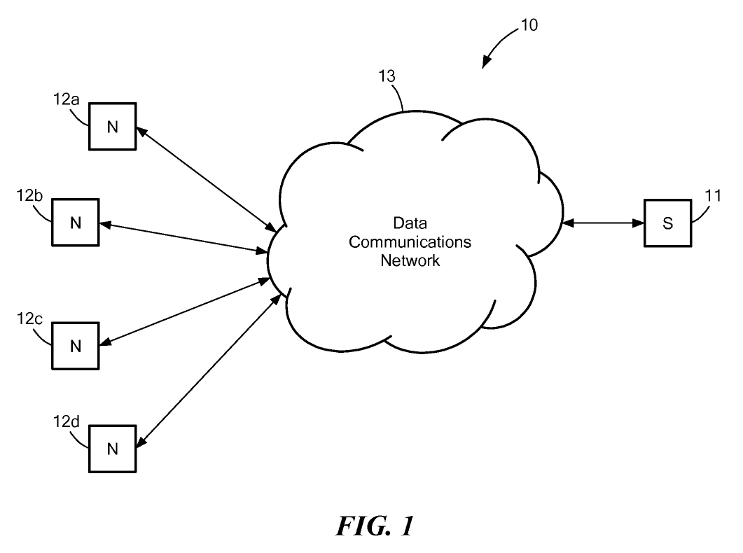

FIG. 1 schematically shows a system 10 for producing digital writings according to an embodiment of the invention. The system includes a server 11 and a plurality of nodes 12a-12d that are connected to each other via a data communications network 13, such as the Internet. The server provides a mechanism for forming one or more online groups that produce digital writings.

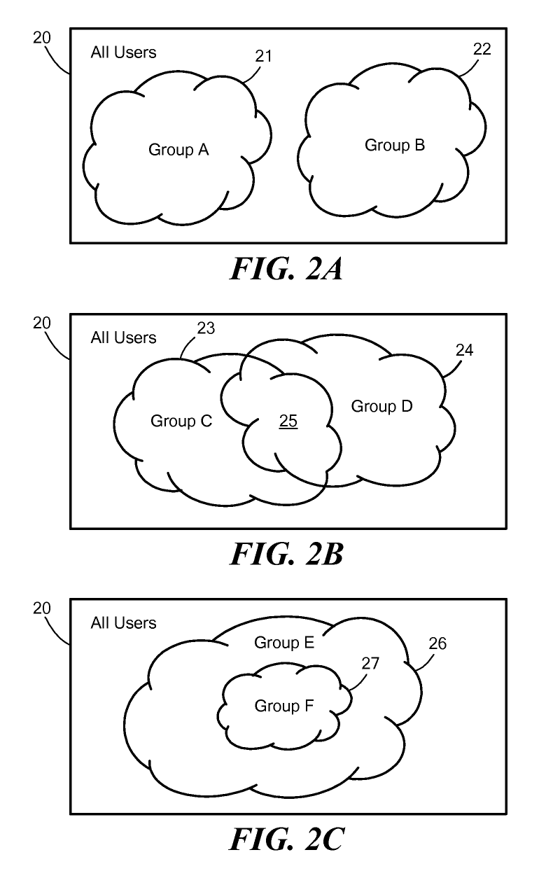

Users of the system access the server from the plurality of nodes. In some embodiments such as that shown in FIG. 1, the server is a centralized, separate, stand-alone computer system. In other embodiments, one of the nodes may be designated to be the server so that the system operates in a peer-to-peer fashion. The system organizes all users into one or more online groups, as shown in FIGS. 2A-2C. In these figures, all users of the system are represented by a large box 20. In FIG. 2A, a subset of the users have been formed into members of a Group A 21 and a subset of the users have been formed into members of a Group B 22. Group A and Group B have no members in common. By contrast, FIG. 2B shows a different situation. In this Figure, some users have become members of Group C 23 and some users have become members of Group D 24. As can be seen, some users 25 are members of both groups. In FIG. 2C, some users have become members of Group E 26, and a subset of these users are also members of Group F 27. Although these figures show two groups, in general embodiments any number of groups may be formed, and any number of overlaps between groups may occur. Thus, a user may be a member of zero, one, or more than one online group. In one embodiment, a global group includes all users as members, although this is not strictly required.

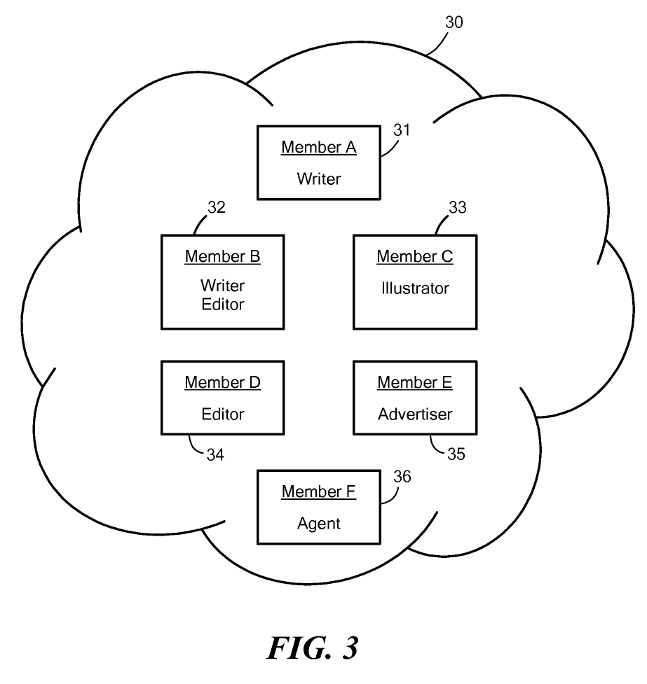

An online group may work together to produce a digital writing. Some of the various roles that members may fulfill are represented in FIG. 3. To this end, an online group 30 is formed that includes two or more members, and different types of work are divided between the members. For example, two members 31, 32 might be assigned to write text, and one member 33 may be assigned to prepare illustrations to supplement the text. Moreover, two members 32, 34 may be assigned to proofread and perform editing. Thus, each member of the group is assigned one or more roles, such as writer, illustrator, editor or proofreader, for producing at least one digital writing within the online group. Each digital writing so produced is conversely associated with one or more roles of a member of the group.

Some members of the group may perform roles that are not related to the production of the digital writing. For example, a group member 35 may be assigned to advertise or promote the digital writing, and another group member 36 may act as a literary agent on behalf of the group, or perform market research to determine the best audience. Further, some group members may perform management functions, such as monitoring the work of the other members in their respective roles. And some group members may simply read the work, for example to serve as critics, or journalists that write stories about the work or a group member, without contributing to production or marketing at all. Nevertheless, at least one member of the group produces the digital writing. It should be noted that in one use case, an author may form an online group for the sole purpose of promoting an already-completed writing. In this case, only one person (the author) produces the digital writing, while the online group may include other members that work on promotion.

There are a number of ways in which roles may be assigned to users of the system. First, the process may be relatively manual. In the first process, a user requests that they be given a role by a system administrator. Once this role is applied, the user may take on that role when they become a member of a group. In a second such process, users do not have pre-defined roles; however, when a user becomes a member of a group, a group leader assigns a role to each user based on their skills. Alternately, the group may vote as a whole to allocate different responsibilities to the various members. In a third process, users do not have pre-defined roles but the server 11 monitors the users (as members of a group) and assigns a role to them based on an analysis of the monitored online activity in the given group. Thus, one user may be a member of two groups but have different roles, that are assigned by the system, in each group.

While it is known for people to collaborate to write books, various embodiments of the present invention provide methods and systems for rating members of an online group based on various objective, measurable parameters. Such parameters may include, for example: the number of times a digital writing produced by the member has been downloaded and read; the number of times the digital writing has been mentioned by other users of the system; the number of users of the system who have officially promoted the digital writing or indicated that they liked reading it; the number of times the digital writing has been mentioned by non-users of the system, for example as measured by a count of unique hits from a search engine; a percentage of the digital writing that is read by an average reader (i.e., do users stop reading after only a few pages, or do they read all the way to the end), and other such measurable, objective parameters. Various embodiments weight and combine these parameters into an “influence” score, with respect to each role that a member has, that indicates how influential or popular a given member is with respect to the given role. Thus, a member may have separate influence scores with respect to his or her work as a writer, as an editor, as an illustrator, as an agent, and so on.

The use of such influence scores has several advantages. When a user of the system wishes to create a new digital writing, he may wish to ask the most influential other users of the system to help. By searching for members based on criteria such as the intended genre, length, or audience for the work, the organizing user may then determine who the most influential users are and ask them to become members of his new online group. Of course, one might expect the most influential users to get many such requests, so the organizing user may prepare a list of other users to ask in ranked order of their influence. Additionally, readers looking for a new book to read may use influence scores to identify good authors to follow. Moreover, by tracking the influence scores over time, one may determine users whose influence is trending in one direction or another. By doing so early, publishers may locate “up and coming” writers, editors, or illustrators long before their writings become commercially popular. They may also identify whether their established writers are becoming more or less popular. As another advantage, such a score may be calculated with respect to either all of a member's digital writings, or only with respect to a given digital writing. The former calculation will yield an overall influence score, while the latter may be used, for example, to facilitate a writing contest or other such event.

In general, an influence score is determined by calculating a weighted sum as follows. First, a numerical weight is assigned to each of the various parameters. Next, the values of the parameters are objectively measured, using whatever techniques are required. Finally, the value for each parameter is multiplied by its weight, and the products are added to produce a final influence score (with respect to the scored parameters).

The weights for any given parameter may be chosen based on a permissible or expected range of values for the parameter and a desired range of contribution of the parameter on the ultimate score. For example, if digital writings are often downloaded tens of thousands of times and the intended contribution of the “downloaded” parameter to the final score should be in the range 0 to 10, then the weight for this parameter might be 0.0001. Thus, a writing that is downloaded 25000 times would add 25000*0.0001=2.5 to the influence score of an associated member of the group that produced it. Similarly, if the score should be increased up to 10 points based on what fraction of the writing is read by an average reader, then the weight for this parameter may be 10. In this way, if the average reader reads 30% of the writing, then the contribution of this parameter to the final score will be 0.30*10=3.0 points.

Weights may be adjusted based on a combination of role and parameter, and in particular based on a perceived contribution of role to the parameter. For example, the system designer may value an editor's contribution more than an advertiser's contribution for the purposes of increasing the average fraction of the work read, while the opposite may be true for purposes of increasing the number of downloads. Thus, the system designer may set the weight for the writer to be proportionately higher for the first parameter, and the weight for the advertiser to be higher for the second parameter.

The parameter values themselves are measured objectively. The number of times a given digital writing has been downloaded may be recorded by the server 11 and stored in a database. The number of digital writings a given member has produced may likewise be tracked by the server 11 in the database. The number of times a given work has been mentioned by other users of the system, for example in an online bulletin board or forum, may be determined by querying the forum software. Other such parameters may be measured and their values stored using techniques known to persons having ordinary skill in the art.

Once the weights have been set and values measured for a particular set of parameters, they are pairwise multiplied and summed to produce a final score. Thus, if there are n parameters in a given score, one computes:

score=(w₁*v₁)+(w₂*v₂)+(w₃*v₃)+ . . . +(Wₙ*Vₙ)

where wᵢ is the weight of the i-th parameter and vᵢ is the value of the i-th parameter. The final score may be computed from the weights and values using techniques known in the art. Based on the weights chosen, the final influencer score may fall within a predefined scale that has a maximum and a minimum.

There are at least four aspects in which one may view an influence score, each giving rise to a different set of parameters that are used in its computation. First, a score may be computed with respect to the perception of a member by others within the online community. Second, a score may be computed with respect to the value of a member's contribution to a given digital writing. Third, a score may be computed with respect to a category of digital writing, such as “science fiction”, “teen literature”, or “self-improvement”. Fourth, these (partial) influence scores may be combined to produce an overall influence score that reflects both an individual's standing in the community, in a given category of writing, and their technical contribution to various works. The various online aspects of these scores may be monitored, at least in part, in a computer process.

A perception score may be formed using objectively measurable parameters that reflect how a given member is viewed by others in the online community. Parameters that might contribute to such a score include a number of “likes” or recommendations made for digital writings produced by the member, especially from other users who have the same role or roles as the given member; an average user-voted “score” (e.g., from 1 star to 5 stars) for digital works produced by the member; and the average number of times digital writings produced by the member are downloaded. Such a perception score may provide the member, or others thinking about forming or already in a collaborative writing group with the member, how well the community views digital writings produced by the member. As noted above, such a score is useful in its own right as an indicator of popularity of the member in their particular role. A member may have a high perception score as a writer but not as an illustrator, or vice versa. A collection of perception scores with respect to different roles may form a multi-axis popularity profile for the member.

A score with respect to an individual work also may be computed. Such a work score includes different parameters than the perception score. For example, a work score may include total hours spent working on the given digital writing, number of check ins and updates made to the writing by the member, number of words written or illustrations created, and so on. This score may be used as an indication of the overall value of a given member with respect to producing (or marketing) a particular digital work. Such a work score may provide the writing group information about how well the member is contributing to the digital writing being produced by the group. Such a score may be used to assist the group in working toward a goal, such as a budget or a deadline. A collection of work scores with respect to a member's different roles in the group may form a multi-axis work rate profile for the member.

A perception score and a work score may be combined to form a composite score. Such a composite score represents both a member's (perceived) value in the community at large and the member's value with respect to a given digital writing. The scores may be combined, for example, by taking the average of the perception score and the work score. More generally, the scores may be combined by forming a weighted sum according to the formula

combined_score=w*perception_score+(1−w)*work_score

where w is a weighting parameter that accounts for a relative importance of the two scores with respect to each other. If w=0.5, this formula produces the average score described above. Alternatively, the two scores may be combined by addition, or according to some other formula.

The numerical influencer score for a given member in a role may be tracked over time. Tracking the score over a time period provides useful information about the waxing or waning popularity of the user in the community, and/or their activity level with respect to contributions to individual digital writings. In particular, a rate of change (derivative) of the score over time may be calculated, thereby providing an indication of trends in these measurements of the member. A positive rate of change in the perception score means that the user is becoming more popular in the community as a whole, while a negative rate of change indicates declining popularity. Similarly, a positive rate of change in a work score for a given digital writing means that the user (as a member of the group producing the writing) is increasing their usefulness or activity with respect to producing the writing, whereas a negative rate of change may indicate that the member's activity is declining. These rates of change may be used to promote an “up-and-coming” editor or illustrator in the first instance, or to encourage a user to remain active in the second instance. Furthermore, the scores of all members of a given group may be formed into a rating list that lists each member as a function of the rate of change of the numerical influencer score. With respect to a given role, the rate list objectively indicates the rate of change of influence of the members in the role. If the scores of all users having that role as a member of any group are formed into a list, then one obtains an objective ranking of all users in the system with respect to that role.

When calculating numerical influencer scores over time, the scores may be adjusted as members are dynamically added. For example, a group leader may allocate “shares” of the work score to all editor members of a group working on a given digital writing. In one embodiment, each editor is permitted to have an equal share of the final score. In another embodiment, one editor may have twice the share of the other editor, at the discretion of the group leader. As new members are added and as members leave, these shares may be adjusted manually by the group leader. In another embodiment, the server 11 allocates shares evenly between all of the editors.

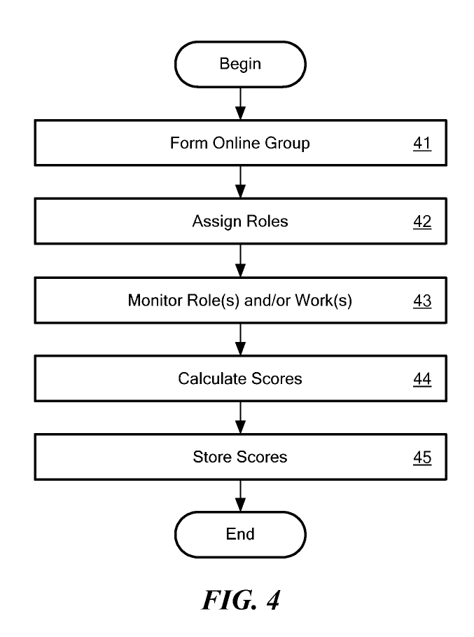

A complete method for objectively rating members of an online group using the above techniques is described with reference to FIG. 4. The method presupposes the existence of a collaborative writing system having a plurality of users. The method begins by forming 41 an online group comprising a plurality of members. The members of the group are selected from the plurality of users, and one or more members of the group each produce at least one digital writing within the online group. The method continues by assigning 42 one or more roles to each of the members within the group. As noted above, the roles may be assigned manually or automatically. Next, the online activity of each member in the group is monitored 43 in two different ways. First, activity is monitored with regard to other users of the community, especially other users and group members who have the same role or roles as the given member. Second, activity is monitored with regard to the one or more digital writings produced by the members of the group. Such monitoring is performed at least in part in a computer process, to permit the method to scale to large numbers of users, members, groups, roles, and digital writings. Then, for each member, one calculates 44 one or more numerical influencer scores for each member by assigned role as a function of the monitored online activity. The influencer score indicates the influence of the member in each assigned role within the group. Optionally, the scores are stored in a non-volatile storage medium so that they may be later displayed to other users of the writing community, including other members of the group. The method may be iterated at different times to produce different scores.

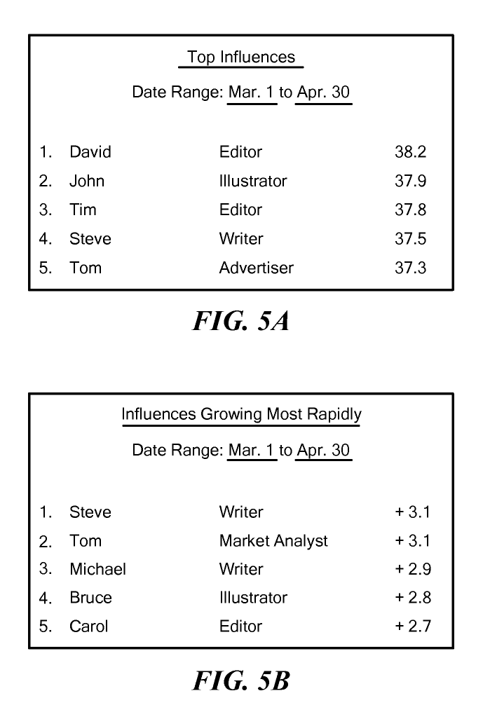

FIG. 5A shows how the top influencer scores might be displayed in a graphical display. There are any number of ways to display the scores; for example, as shown in FIG. 5A, a user may select a date range over which to show scores, such as between March 1 and April 30 of a given year. Other displays are contemplated, such as the highest and lowest scores in a date range, and the score of a member on a given date, and a person having ordinary skill in the art may devise other such displays. In the example of FIG. 5A, David has the highest influencer score of 38.2 in his role as an editor. Other members are given scores in their roles as well, such as Steve as a writer and Tom as an advertiser.

FIG. 5B shows how the influencer scores change over time. Thus, Steve's score as a writer improved by 3.1 points, the most of any member of the two month time frame indicated. Tom has a top five score in his advertiser role, but his score as a market analyst showed the second best improvement over the given time frame. The indicated scores and gains are exemplary only; other such displays are contemplated, such as displays for scores shrinking most rapidly, and for instantaneous score movement in units of points per day.

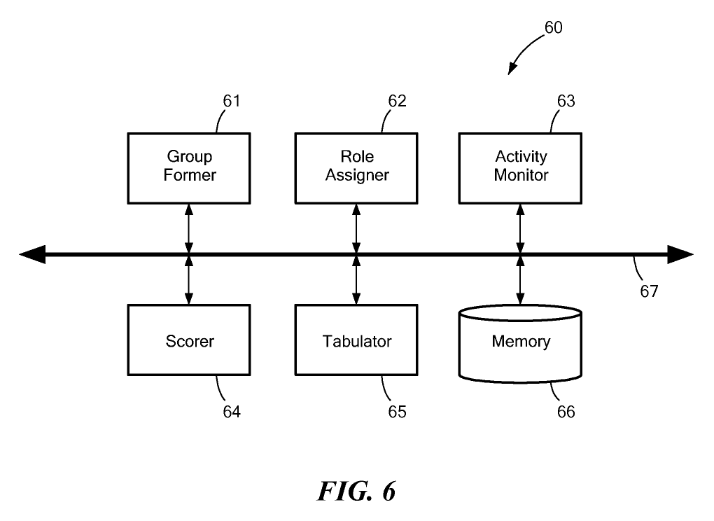

FIG. 6 schematically shows various relevant modules that are used in constructing an apparatus to implement the methods described herein. The modules may be formed from hardware, software, firmware, or a combination of these, provided that they are at least partially formed from hardware. The modules are typically implemented as part of server 11. A group formation module 61 is configured to form groups having members. As noted above, members are taken from users of an online writing community. A role assignment module 62 is configured to assign one or more roles to each of the members within the group. An activity monitor 63 is configured to monitor the online activity of each member of the group with regard to the other members and users of the system 10, and with regard to one or more digital writings produced by the members of the group. A scorer 64 is configured to calculate, for each member, a numerical influencer score as described above. A tabulator 65 is configured to calculate, for each member, a rate of change of the numerical influencer score for at least one of the roles over a given time period. The tabulator is also configured to form a rate list that lists each member as a function of the calculated rate of change. A non-volatile memory 66 is configured to store at least data pertaining to the users, the formed groups and their members, the roles of the various members, and the calculated scores and rates of change. The group formation module, role assignment module, activity monitor, scorer, tabulator, and memory are coupled via a data communications system 67 that may be, for example, one or more data buses inside a computer.

Although the above discussion discloses various exemplary embodiments of the invention, it should be apparent that those skilled in the art can make various modifications that will achieve some of the advantages of the invention without departing from the true scope of the invention.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

What is claimed is:

1. A method of objectively rating users of a collaborative writing system, the method comprising:
forming an online group comprising a plurality of members, each member being a user of the collaborate writing system, one or more members of the group each producing at least one digital writing within the online group;
assigning one or more roles to each of the members within the group, each digital writing being associated with one or more roles of a member;
monitoring, at least in part in a computer process, online activity of each member in the group as judged by other users of the writing system;
monitoring, at least in part in a computer process, online activity of each member in the group with regard to the one or more roles of the member in producing the at least one digital writing; and
for each member, calculating a numerical influencer score for each member by role as a function of the monitored online activity, the influencer score indicating the influence of the member in each assigned role within the group.

2. The method as defined by claim 1, further comprising storing the influencer score(s) in a non-volatile storage medium.

3. The method as defined by claim 1 wherein the online group forms a portion of a larger online group having a plurality of users, the plurality of members being members of the larger online group, the larger online group comprising users that are not members of the online group.

4. The method as defined by claim 1 wherein assigning comprises monitoring, at least in part in a computer process, online activity of the members and assigning the one or more roles to each member based on the monitored activity.

5. The method as defined by claim 1 further comprising:
for each member, calculating the rate of change of the numerical influencer score for at least one of the roles over a time period; and
for the at least one role, forming a rate list that lists each member as a function of the rate of change of the numerical influencer score, the rate list objectively indicating the rate of change of influence of the members in the at least one role.

6. The method as defined by claim 1 wherein forming an online group comprises dynamically adding members over a given period of time while continuing to calculate numerical influencer scores over the given time.

7. The method as defined by claim 1 wherein calculating comprises calculating a weighted sum as a function of the monitored online activity.

8. The method as defined by claim 1 wherein the influencer score falls within a predefined scale having a maximum influencer score and a minimum influencer score.

9. The method as defined by claim 1 wherein the one or more roles comprises a writer, a reader, and an editor.

10. The method as defined by claim 1 further comprising forming a rank listing for each role, each rank listing comprising a list of one or more members of the online group in an order based upon the numerical influencer scores for each member assigned to that role.

11. The method as defined by claim 1 wherein calculating the numerical score comprises calculating, for one of the members, the numerical influencer score as a function of both:
a. the monitored online activity of each member with regard to the one member in his/her role(s), and
b. the monitored online activity of each member in the group with regard to digital writing produced by the one member in his/her role(s).

12. An apparatus for objectively rating members of an online group, the apparatus comprising:
a role assignment module configured to assign one or more roles to each of the members within the group, one or more members of the group each producing at least one digital writing within the online group, each digital writing being associated with one or more roles of a member;
a monitor operatively coupled with the role assignment module, the monitor being configured to monitor, at least in part in a computer process, online activity of each member in the group with regard to 1) other members in their role(s) and 2) the digital writing(s) produced by the one or more members in their role(s); and
a scorer operatively coupled with the monitor, the scorer being configured to calculate, for each member, a numerical influencer score for each assigned role as a function of the monitored online activity, the influencer score indicating the influence of the member in each assigned role within the group.

13. The apparatus as defined by claim 12 wherein the role assignment module is configured to assign the one or more roles to each member based on monitored activity information received from the monitor.

14. The apparatus as defined by claim 12 further comprising a tabulator operatively coupled with the scorer, the tabulator being configured to calculate, for each member, a rate of change of the numerical influencer score for at least one of the roles over a time period, the tabulator also configured to form, for the at least one role, a rate list that lists each member as a function of the rate of change of the numerical influencer score, the rate list objectively indicating the rate of change of influence of the members in the at least one role.

15. The apparatus as defined by claim 12 wherein scorer is configured to calculate the numerical influencer score using a weighted sum, the weighted sum being a function of the monitored online activity.

16. The apparatus as defined by claim 12 further comprising a tabulator operatively coupled with the scorer, the tabulator being configured to form a rank listing for each role, each rank listing comprising a list of one or more members of the online group in an order based upon the numerical influencer scores for each member assigned to that role.

17. The apparatus as defined by claim 12 wherein the scorer is configured to calculate the numerical score by calculating, for one of the members, the numerical influencer score as a function of both:
a. the monitored online activity of each member with regard to the one member in his/her role(s), and
b. the monitored online activity of each member in the group with regard to digital writing produced by the one member in his/her role(s).

18. A computer program product including a non-transitory computer-readable medium having computer code thereon for objectively rating members of an online group, the computer program product comprising:
program code for forming an online group comprising a plurality of members, one or more members of the group each producing at least one digital writing within the online group;
program code for assigning one or more roles to each of the members within the group, each digital writing being associated with one or more roles of a member;
program code for monitoring, at least in part in a computer process, online activity of each member in the group with regard to other members in their role(s);
program code for monitoring, at least in part in a computer process, online activity of each member in the group with regard to the digital writing(s) produced by the one or more members in their role(s); and
program code for calculating, for each member, a numerical influencer score for each assigned role as a function of the monitored online activity, the influencer score indicating the influence of the member in each assigned role within the group.

19. The computer program product as defined by claim 18 further comprising:
program code for calculating, for each member, the rate of change of the numerical influencer score for at least one of the roles over a time period; and
program code for forming, for the at least one role, a rate list that lists each member as a function of the rate of change of the numerical influencer score, the rate list objectively indicating the rate of change of influence of the members in the at least one role.

20. The computer program product as defined by claim 18 wherein the program code for forming an online group comprises program code for dynamically adding members over a given period of time while continuing to calculate numerical influencer scores over the given time.

21. The computer program product as defined by claim 18 wherein the program code for calculating comprises program code for calculating a weighted sum as a function of the monitored online activity.

22. The computer program product as defined by claim 18 further comprising program code for forming a rank listing for each role, each rank listing comprising a list of one or more members of the online group in an order based upon the numerical influencer scores for each member assigned to that role.

23. The computer program product as defined by claim 18 wherein the program code for calculating the numerical score comprises program code for calculating, for one of the members, the numerical influencer score as a function of both:
a. the monitored online activity of each member with regard to the one member in his/her role(s), and
b. the monitored online activity of each member in the group with regard to digital writing produced by the one member in his/her role(s).
